(19) United States
(12) Patent Application Publication
(10) Pub. No.: US 2020/0204925 A1
(43) Pub. Date: Jun. 25, 2020

(54) MEMS MICROPHONE

(71) Applicant: GOERTEK INC., Weifang City, Shandong (CN)

(72) Inventors: Quanbo ZOU, Weifang City (CN); Zhe WANG, Weifang City (CN); Yongwei DONG, Weifang City (CN)

(73) Assignee: Goertek Inc., Weifang City, Shandong (CN)

(21) Appl. No.: 15/751,191

(22) PCT Filed: Nov. 30, 2017
(86) PCT No.: PCT/CN2017/113952

§ 371 Date: Feb. 8, 2018

(30) Foreign Application Priority Data
Nov. 24, 2017 (CN) 201711192077.3

(51) Int. Cl. H04R 19/04; H04R 7/02; H04R 19/00; H04R 1/04

(52) U.S. Cl. CPC H04R 19/04; H04R 7/02; H04R 2201/003; H04R 1/04; H04R 19/005

(57) ABSTRACT

A MEMS microphone, which comprises a substrate, a first vibrating diaphragm and a second vibrating diaphragm is provided. A sealed cavity is formed between the first vibrating diaphragm and the second vibrating diaphragm. A back electrode unit is located in the sealed cavity, forms a capacitor structure with the first vibrating diaphragm and with the second vibrating diaphragm respectively, and is provided with a plurality of through holes that penetrate through two sides thereof. The sealed cavity is filled with a gas whose viscosity coefficient is smaller than that of air. According to the MEMS microphone disclosed by the present invention, by filling the sealed cavity with a gas whose viscosity coefficient is smaller than that of air, the acoustic resistance when the two vibrating diaphragms move relative to the back electrode can be reduced greatly, thereby reducing the noise of the microphone. Meanwhile, by the use of a gas with a low viscosity coefficient for filling, the pressure in the sealed cavity is consistent with the pressure of an external environment, thereby avoiding the problem of vibrating diaphragm deflection caused by pressure difference and ensuring the performances of the microphone.

### CROSS-REFERENCE TO RELATED APPLICATIONS

This application is a National Stage of International Application No. PCT/CN2017/113952, filed on Nov. 30, 2017, which claims priority to Chinese Patent Application No. 201711192077.3, filed on Nov. 24, 2017, both of which are hereby incorporated by reference in their entireties.

### BACKGROUND

### Technical Field

The present invention relates to the field of acoustic-electronics, in particular to a microphone, and more particularly to an MEMS microphone.

### Description of Related Art

The MEMS (Micro Electro Mechanical System) microphone is a microphone made based on the MEMS technology. A vibrating diaphragm and a back electrode are important components in the MEMS microphone and form a capacitor integrated on a silicon wafer, thereby realizing the acoustic-electric conversion.

Such a traditional capacitive microphone is generally provided with through holes on its back electrode in order to balance the pressure between the vibrating diaphragm and the back electrode. On the other hand, however, the through holes form a damper-like capillary sound absorption structure which increases the acoustic resistance on the sound transmission path. The increase of the acoustic resistance means the increase of the background noise caused by the thermal noise of air, thereby reducing the SNR eventually. On the other hand, air damping also occurs in a gap between the vibrating diaphragm and the back electrode, which is another important factor in the acoustic impedance of the microphone noise. The air damping is usually the main contributor to microphone noise, which is the bottleneck for implementing high signal-to-noise (SNR) microphones.

A dual-vibrating-diaphragm microphone structure appears in the existing market. Two vibrating diaphragms of the microphone structure define an airtight sealed cavity for. A central back electrode with through holes is provided between the two vibrating diaphragms and located in the sealed cavity of the two vibrating diaphragms, and forms a differential capacitor structure together with the two vibrating diaphragms. One or more support columns for supporting the central positions of the two vibrating diaphragms are also provided.

The microphone of such a structure, especially in which the sealed cavity is filled with air, has higher acoustic impedance compared to the traditional microphone, and thereby has higher noise. In addition, when the pressure in the sealed cavity is greater than the external pressure, each of the two vibrating diaphragms will bulges toward the direction of away from the other, whereas the two vibrating diaphragms will be deformed (deflated) towards the back electrode. As the changes of the gap between the two vibrating diaphragms, the changes in the ambient static pressure can affect the performances (e.g., sensitivity) of the microphone. Especially when the temperature rises, the pressure difference between the surrounding environment and the sealed cavity is larger.

In addition, the arrangement of the support columns causes the rigidity of the vibrating diaphragms to be larger so that the vibrating diaphragms cannot characterize the sound pressure well, which reduces the vibration sensitivity of the vibrating diaphragms and thus affects the performances of the microphone to some degree.

### BRIEF SUMMARY

An objective of the present invention provides a new technical solution of a MEMS microphone.

According to the first aspect of the present invention, there is provided a MEMS microphone, comprising: a substrate; a first vibrating diaphragm and a second vibrating diaphragm between which a sealed cavity is formed; and a back electrode unit which is located in the sealed cavity, forms a capacitor structure with the first vibrating diaphragm and with the second vibrating diaphragm respectively and is provided with a plurality of through holes that penetrate through two sides thereof; wherein, the sealed cavity is filled with a gas whose viscosity coefficient is smaller than that of air.

Optionally, the gas is selected from at least one of isobutene, propane, propylene, H₂, ethane, ammonia, acetylene, ethyl chloride, ethylene, CH₃Cl, methane, SO₂, H₂S, chlorine, CO₂, N₂O and N₂.

Optionally, the pressure of the sealed cavity is consistent with that of the external environment.

Optionally, the pressure of the sealed cavity is one standard atmospheric pressure.

Optionally, the pressure difference between the sealed cavity and the external environment is less than 0.5 atm.

Optionally, the pressure difference between the sealed cavity and the external environment is less than 0.1 atm.

Optionally, a gap between the back electrode unit and each of the first vibrating diaphragm and the second vibrating diaphragm is 0.5-3 μm.

Optionally, one or more support columns are also arranged between the first vibrating diaphragm and the second vibrating diaphragm and penetrate through the through holes of the back electrode unit, and two ends of each of the support columns are connected to the first vibrating diaphragm and the second vibrating diaphragm respectively.

Optionally, the material of the support columns is the same as that of the first vibrating diaphragm and/or the second vibrating diaphragm.

Optionally, the support columns are made of an insulating material.

Optionally, the back electrode unit is a back electrode plate which forms the capacitor structure with the first vibrating diaphragm and with the second vibrating diaphragm respectively.

Optionally, the back electrode unit comprises a first back electrode plate for forming one capacitor structure with the first vibrating diaphragm, and a second back electrode plate for forming another capacitor structure with the second vibrating diaphragm; and an insulating layer is arranged between the first back electrode plate and the second back electrode plate.

Optionally, the sealed cavity is sealed at room temperature and normal pressure.

Optionally, the MEMS microphone further comprises a pressure relief hole which penetrates through the first vibrating diaphragm and the second vibrating diaphragm, wherein the wall of the pressure relief hole defines the sealed cavity together with the first vibrating diaphragm and the second vibrating diaphragm.

Optionally, only one pressure relief hole, which goes through the middle of the first vibrating diaphragm and the middle of the second vibrating diaphragm, is provided; or a plurality of pressure relief holes is provided.

According to the MEMS microphone disclosed by the present invention, by filling the sealed cavity with a gas whose viscosity coefficient is smaller than that of air, the acoustic resistance when the two vibrating diaphragms move relative to the back electrode can be reduced greatly, thereby reducing the noise of the microphone. Meanwhile, by the use of a gas with a low viscosity coefficient for filling, the pressure in the sealed cavity is consistent with the pressure of an external environment, thereby avoiding the problem of vibrating diaphragm deflection caused by pressure difference and ensuring the performances of the microphone.

Other features and advantages of the present invention will become apparent from the following detailed description of exemplary embodiments of the present invention with reference to the accompanying drawings.

### BRIEF DESCRIPTION OF THE FIGURES

The accompanying drawings, which constitute a part of the description, illustrate embodiments of the present invention and, together with the description thereof, serve to explain the principles of the present invention.

FIG. 1 is a schematic structural drawing of the first embodiment of a microphone of the present invention.

FIG. 2 is a schematic structural drawing of the second embodiment of the microphone of the present invention.

FIG. 3 is a schematic structural drawing of the third embodiment of the microphone of the present invention.

### DETAILED DESCRIPTION OF VARIOUS EMBODIMENTS

Various exemplary embodiments of the present invention will now be described in detail with reference to the accompanying drawings. It should be noted that the relative arrangement, numerical expressions and numerical values of the components and steps set forth in these embodiments do not limit the scope of the present invention unless otherwise specified.

The following description of at least one exemplary embodiment is in fact merely illustrative and is in no way intended as a limitation to the present invention and its application or use.

Techniques and devices known to those of ordinary skill in the relevant art may not be discussed in detail but where appropriate, the techniques and devices should be considered as part of the description.

Among all the examples shown and discussed herein, any specific value should be construed as merely illustrative and not as a limitation. Thus, other examples of exemplary embodiments may have different values.

It should be noted that similar reference numerals and letters denote similar items in the accompanying drawings, and therefore, once an item is defined in a drawing, there is no need for further discussion in the accompanying drawings.

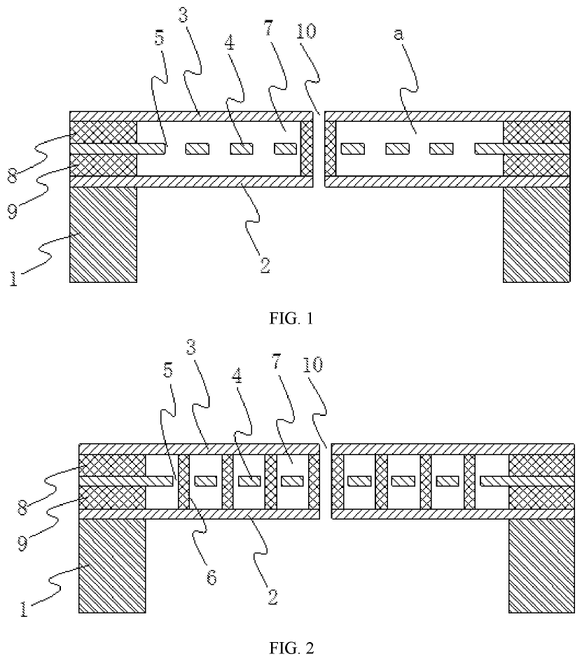

Referring to FIG. 1, a MEMS microphone provided by the present invention is a dual-vibrating-diaphragm microphone structure. The MEMS microphone comprises a substrate 1, and a first vibrating diaphragm 3, a second vibrating diaphragm 2 and a back electrode unit, which are formed on the substrate 1. The vibrating diaphragms and the back electrode unit of the present invention can be formed on the substrate 1 by means of deposition and etching. The substrate 1 can be made of single crystal silicon material, and the vibrating diaphragms and the back electrode unit can be made of single crystal silicon material or polycrystalline silicon material. The selection of such material and the deposition process are well-known to those skilled in the art and will not be described in detail herein.

Referring to FIG. 1, the central region of the substrate 1 is provided with a back cavity. In order to ensure the insulation between the second vibrating diaphragm 2 and the substrate 1, an insulating layer is arranged in a position where the second vibrating diaphragm 2 and the substrate 1 are connected. The insulating layer can be made of silica material well-known to those skilled in the art.

In the present embodiment, the back electrode unit of the present invention is a back electrode plate 4 which is provided with a plurality of through holes 5 that penetrate through two sides thereof. The back electrode plate 4 is connected to the upper side of the second vibrating diaphragm 2 by means of the supporting of a first support portion 9, such that there is a gap between the back electrode plate 4 and the second vibrating diaphragm 2, which constitutes a capacitor structure. The first vibrating diaphragm 3 is connected to the upper side of the back electrode plate 4 by means of the supporting of a second support portion 8, such that there is a gap between the first vibrating diaphragm 3 and the back electrode plate 4, which constitutes a capacitor structure. The first support portion 9 and the second support portion 8 are made of an insulating material, and also capable of ensuring the insulation between the two vibrating diaphragms and the back electrode plate while playing a supporting role. Such structural form and the selection of materials are well-known to those skilled in the art and will not be described in detail herein.

The back electrode plate 4 is arranged between the first vibrating diaphragm 3 and the second vibrating diaphragm 2, and the three constitute a sandwich-like structure. The two capacitor structures formed above can form a differential capacitor structure to improve the accuracy of the microphone. This is a structural feature of the dual-vibrating-diaphragm microphone and will not be specifically described herein.

Preferably, the back electrode plate 4 is arranged in the middle of the space between the first vibrating diaphragm 3 and the second vibrating diaphragm 2. That is to say, the distance from the back electrode plate 4 to the first vibrating diaphragm 3 is equal to the distance from the back electrode plate 4 to the second vibrating diaphragm 2. In a specific embodiment of the present invention, the distances from the back electrode plate 4 to the two vibrating diaphragms may be 0.5-3 μm respectively, and will not be specifically described again.

Referring to FIG. 1, a sealed cavity a is formed between the first vibrating diaphragm 3 and the second vibrating diaphragm 2. In the present embodiment, the first vibrating diaphragm 3 and the second vibrating diaphragm 2 are provided at the upper side and the lower side of the sealed cavity a, and the first support portion 9 and the second support portion 8 are provided at the left side and the right side of the sealed cavity a, which together form the airtight sealed cavity a.

Specifically, at the time of manufacturing, for example, deposition and etching may be performed by a conventional MEMS process, and then an internal sacrificial layer may be etched away through an etching hole provided on the first vibrating diaphragm 3 to release the first vibrating diaphragm 3 and the second vibrating diaphragm 2. Finally, the etching hole on the first vibrating diaphragm 3 is plugged, so as to form the sealed cavity a.

In the above description, the etching hole for etching is provided on the first vibrating diaphragm 3, which is only an example. Of course, for those skilled in the art, the etching hole can also be provided on the second vibrating diaphragm 2. Of course, if the process allows, the etching hole may also be provided on the first support portion 9 and the second support portion 8. After the internal sacrificial layer is etched away, the etching hole can be plugged to form the airtight sealed cavity a. For example, a plugging portion may be formed at the edge of the sealed cavity a to plug the etching hole provided at the edge of the sealed cavity a.

Because the back electrode plate 4 is provided with a plurality of through holes 5, the sealed cavity a separated by the back electrode plate 4 can communicate with each other through the through holes 5. The sealed cavity a is filled with a gas whose viscosity coefficient is smaller than that of air.

The viscosity coefficient expresses the internal friction force caused by the interaction of gas molecules under stress, and is usually related to temperature and pressure. Therefore, the gas whose viscosity coefficient is smaller than that of air is the gas whose viscosity coefficient is smaller than that of air under the same conditions. The same conditions may be, for example, within the operating condition range of the microphone, for example, from −20° C. to 100° C. Of course, some microphones need to operate in extreme environments, depending on the application fields of the microphone.

For example, under the standard atmospheric pressure condition, the viscosity coefficient of air μ_{air 0° C.} at 0° C. is about 1.73×10⁻⁵ Pa·s, and the viscosity coefficient of hydrogen μ_{hydrogen 0° C.} at 0° C. is about 0.84×10⁻⁵ Pa·s, which is far smaller than the viscosity coefficient of air at 0° C. At the temperature of 20° C., the viscosity coefficient of air μ_{air 20° C.} about 1.82×10⁻⁵ Pa·s, and the viscosity coefficient of hydrogen μ_{hydrogen 20° C.} is about 0.88×10⁻⁵ Pa·s, which is far smaller than the viscosity coefficient of air at 20° C.

Although the viscosity coefficient of gas μ increases as the temperature rises, it can be seen from the above data that the viscosity coefficient of hydrogen μ_{hydrogen 20° C.} at 20° C. is much smaller than the viscosity coefficient of air μ_{air 0° C.} at 0° C.

Therefore, the sealed cavity a may be filled with hydrogen, such that the gas in the sealed cavity a has a smaller viscosity coefficient, which is equivalent to reducing the acoustic resistance of the two vibrating diaphragms when moving relative to the back electrode, thereby reducing the noise of the microphone.

In the prior art, there are many gases with lower viscosity coefficients than air. It is possible to select those gases whose viscosity coefficients are smaller than the viscosity coefficient of air under the working conditions of the microphone. These gases may be, for example, selected from at least one of isobutene, propane, propene, H₂, ethane, ammonia, acetylene, ethyl chloride, ethylene, CH₃Cl, methane, SO₂, H₂S, chlorine, CO₂, N₂O and N₂.

The viscosity coefficient of the gas μ is directly related to the acoustic impedance Ra of the microphone. The acoustic resistance of the microphone mainly includes the acoustic resistance Ra.gap between gaps between the vibrating diaphragms and the back electrode plate and the acoustic resistance Ra.hole at the through holes of the back electrode plate, wherein:

Ra.gap=12μ/(πng³ Sₘₑₘ)·(A/2−A²/8−ln A/4−3/8); where n is the density of the through holes, g is the size of the gap, Sₘₑₘ is the area of the vibrating diaphragm, and A is the area ratio of the through holes to the back electrode plate.

Ra.hole=8 μT/(πr⁴N); where T is the thickness of each through hole, r is the radius of each through hole, and N is the total number of the through holes.

Then, the acoustic resistance Ra of the microphone is Ra.gap+Ra.hole.

As can be seen from the above formula, the viscosity coefficient μ of the gas is proportional to the acoustic resistance Ra of the microphone. That is, when the viscosity coefficient μ of the gas in the sealed cavity a is smaller, the acoustic resistance Ra of the microphone is smaller.

In addition, the noise power spectral density PSD (f) of the microphone is proportional to 4KTRa, wherein f is the frequency, K is the Boltzmann's constant and T is the temperature (unit: Kelvin). The noise N (amplitude) in the SNR calculation formula is the square root of the weighted integral of the PSD within the desired frequency bandwidth (e.g., 20 Hz-20 kHz). Therefore, the noise N (amplitude) is proportional to the square root of the viscosity coefficient of the gas μ.

According to the above calculation formula, if the viscosity coefficient μ of the gas in the sealed cavity a is reduced by a half, the acoustic resistance Ra is also reduced by a half, so the noise N will be changed by 10×log(½)=−3 dB, which is commendable for high-performance MEMS microphones.

Another advantage of using the gas with low viscosity coefficient to fill the sealed cavity is that: the pressure in the sealed cavity a can be kept to be consistent with the pressure of the external environment. For example, when hydrogen is filled and the cavity is sealed, sealing can be performed in a hydrogen atmosphere and at room temperature (indoor temperature) and normal pressure (or near one atmospheric pressure) to compensate for the pressure of the external environment. That is to say, the pressure difference between the airtight sealed cavity a and the external environment is zero, so that the first vibrating diaphragm 3 and the second vibrating diaphragm 2 in a static state can be kept flat without the problems of bulging or deflation. This avoids the use of the support columns between two vibrating diaphragms, which can improve the sensitivity of the microphone to ensure the acoustic performance of the microphone.

Although the pressure of the external environment changes, the pressure in the sealed cavity a after the encapsulation is constant, however, the pressure in the sealed cavity a is enabled to be as close to the pressure of the external environment as possible, for example, the pressure of the sealed cavity a can be selected as one standard atmospheric pressure. Therefore, the pressure difference between the sealed cavity a and the external environment can be minimized so as to reduce the deflection degree of the vibrating diaphragms due to the pressure difference, thereby ensuring the performance (sensitivity) of the microphone.

In addition, due to the manufacturing process, the pressure in the sealed cavity a may be different from the pressure in the external environment. This difference is preferably less than 0.5 atm (standard atmospheric pressure), and more preferably less than 0.1 atm (standard atmospheric pressure).

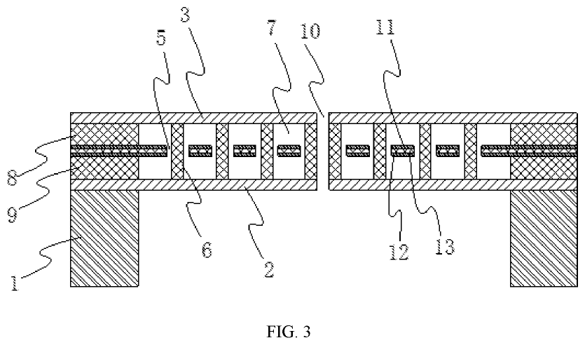

Of course, in order to solve the problem of deflection of the vibrating diaphragms due to the pressure difference between the sealed cavity a and the external environment, referring to FIG. 2, the support columns 6 may be arranged between the two vibrating diaphragms. The support columns 6 pass through the through holes 5 of the back electrode plate 4, and both ends of each of the support columns 6 are respectively connected with the first vibrating diaphragm 3 and the second vibrating diaphragm 2. A plurality of support columns 6 may be arranged, which are evenly distributed between the two vibrating diaphragms, such that when there is a pressure difference between the sealed cavity a and the external environment, the support columns 6 connected between the two vibrating diaphragms can resist the deflection of the vibrating diaphragms.

Since the pressure difference between the sealed cavity a and the external environment may be caused by the manufacturing process, the pressure difference caused by such process error will not be large. Or when the microphone is in use, the pressure of the external environment thereof will change, but this change will not be large either. Therefore, it is possible to select a small amount of support columns 6, or select support columns 6 with a large aspect ratio, i.e., elongated support columns 6 for supporting. This can significantly improve the acoustic performance (sensitivity) of the microphone compared with the use of a large number of support columns with a small aspect ratio.

The support columns of the present invention can be made of the same material as the first vibrating diaphragm 3 and/or the second vibrating diaphragm 2. For example, the support columns 6 can be formed between the first vibrating diaphragm 3 and the second vibrating diaphragm 2 by layer-by-layer deposition and layer-by-layer etching at the time of deposition, and can be released by subsequent etching, which belongs to the common general knowledge for those skilled in the art and will not be described in detail herein.

Since the first vibrating diaphragm 3 and the second vibrating diaphragm 2 are used as one of the electrode plates of the capacitor, it is necessary to adopt a conductive material. When the support columns 6 are made of the same conductive material as the first vibrating diaphragm 3 and/or the second vibrating diaphragm 2, the first vibrating diaphragm 3 and the second vibrating diaphragm 2 will be short-circuited. In this case, the back electrode unit needs to adopt a dual-electrode structure.

Referring to FIG. 3, the back electrode unit comprises a first back electrode plate 11 for forming one capacitor structure with the first vibrating diaphragm 3, and a second back electrode plate 12 for forming another capacitor structure with the second vibrating diaphragm 2; and an insulating layer 13 is arranged between the first back electrode plate 11 and the second back electrode plate 12. The first back electrode plate 11, the insulating layer 13 and the second back electrode plate 12 may be stacked together to form the back electrode unit, which improves the rigidity of the back electrode unit.

The capacitor consisting of the first vibrating diaphragm 3 and the first back electrode plate 11 is denoted as C1, the capacitor consisting of the second vibrating diaphragm 2 and the second back electrode plate 12 is denoted as C2, and the capacitor C1 and the capacitor C2 form a differential capacitor structure.

In another specific embodiment of the present invention, the support columns 6 may be made of an insulating material to ensure the insulation between the first vibrating diaphragm 3 and the second vibrating diaphragm 2. In this case, the structure of a single back electrode plate 4 as shown in FIG. 2 may be adopted, which will not be described in detail.

In addition, it is preferable to further include a pressure relief hole 10 penetrating through the first vibrating diaphragm 3 and the second vibrating diaphragm 2 so as to reduce the acoustic resistance with the external environment and the back cavity when the dual vibrating diaphragms vibrate. It should be noted that, due to the formation of the sealed cavity a between the first vibrating diaphragm 3 and the second vibrating diaphragm 2, in order to avoid the communication between the pressure relief hole 10 and the sealed cavity a, the hole wall of the pressure relief hole 10, the first vibrating diaphragm 3 and the second vibrating diaphragm 2 define the above-mentioned sealed cavity a, referring to FIG. 1 and FIG. 2.

In a specific embodiment, one pressure relief hole 10, which goes through the middle of the first vibrating diaphragm and the middle of the second vibrating diaphragm, may be provided. It is also possible to provide a plurality of pressure relief holes 10, which is distributed in the horizontal direction of the first vibrating diaphragm 3 and the second vibrating diaphragm 2. Each pressure relief hole 10 occupies the volume of the sealed cavity a to separate the pressure relief hole 10 from the sealed cavity a, which will not be described in detail herein.

While certain specific embodiments of the present invention have been illustrated in detail by way of example, it should be understood by those skilled in the art that the foregoing examples are provided for the purpose of illustration and are not intended to limit the scope of the present invention. It should be understood by those skilled in the art that the foregoing embodiments may be modified without departing from the scope and spirit of the invention. The scope of the present invention is subject to the attached claims.

1-15. (canceled)

16. An MEMS microphone, comprising:
a substrate;
a first vibrating diaphragm and a second vibrating diaphragm between which a sealed cavity is formed; and
a back electrode unit, which is located in the sealed cavity, forms a capacitor structure with the first vibrating diaphragm and with the second vibrating diaphragm respectively, and is provided with a plurality of through holes that penetrate through two sides of the back electrode unit,
wherein the sealed cavity is filled with a gas whose viscosity coefficient is smaller than that of air.

17. The MEMS microphone according to claim 16, wherein the gas is selected from at least one of isobutene, propane, propylene, H₂, ethane, ammonia, acetylene, ethyl chloride, ethylene, CH₃Cl, methane, SO₂, H₂S, chlorine, CO₂, N₂O, or N₂.

18. The MEMS microphone according to claim 16, wherein the pressure of the sealed cavity is consistent with that of an external environment.

19. The MEMS microphone according to any of claims 16, wherein the pressure of the sealed cavity is one standard atmospheric pressure.

20. The MEMS microphone according to claim 16, wherein the pressure difference between the sealed cavity and an external environment is less than 0.5 atm.

21. The MEMS microphone according to claim 20, wherein the pressure difference between the sealed cavity and the external environment is less than 0.1 atm.

22. The MEMS microphone according to claim 16, wherein a gap between the back electrode unit and each of the first vibrating diaphragm and the second vibrating diaphragm is 0.5-3 μm.

23. The MEMS microphone according to claim 16, wherein:
one or more support columns are also arranged between the first vibrating diaphragm and the second vibrating diaphragm and penetrate through the through holes of the back electrode unit, and
two ends of each of the support columns are connected to the first vibrating diaphragm and the second vibrating diaphragm respectively.

24. The MEMS microphone according to claim 23, wherein the material of the support columns is the same as that of the first vibrating diaphragm and/or the second vibrating diaphragm.

25. The MEMS microphone according to claim 23, wherein the support columns are made of an insulating material.

26. The MEMS microphone according to claim 16, wherein the back electrode unit is a back electrode plate which forms the capacitor structure with the first vibrating diaphragm and with the second vibrating diaphragm respectively.

27. The MEMS microphone according to claim 16, wherein:
the back electrode unit comprises a first back electrode plate for forming one capacitor structure with the first vibrating diaphragm and a second back electrode plate for forming another capacitor structure with the second vibrating diaphragm; and
an insulating layer is arranged between the first back electrode plate and the second back electrode plate.

28. The MEMS microphone according to claim 16, wherein the sealed cavity is sealed at room temperature and normal pressure.

29. The MEMS microphone according to claim 16, further comprising a pressure relief hole which penetrates through the first vibrating diaphragm and the second vibrating diaphragm, wherein the wall of the pressure relief hole defines the sealed cavity together with the first vibrating diaphragm and the second vibrating diaphragm.

30. The MEMS microphone according to claim 29, wherein either:
one pressure relief hole, which goes through the middle of the first vibrating diaphragm and the middle of the second vibrating diaphragm, is provided; or
a plurality of pressure relief holes are provided.
